(19) United States
(12) Patent Application Publication
(10) Pub. No.: US 2017/0259514 A1
(43) Pub. Date: Sep. 14, 2017

(54) REPAIR PATCH FOR ROTOR BLADE

(71) Applicant: Philmore H. COLBURN, II, Stratford, CT (US)

(72) Inventors: Yih-Farn Chen, Shelton, CT (US); Joshua Mancher, Beverly Hills, CA (US); Marcus D. Cappelli, Shelton, CT (US); Jeffrey R. Schaff, North Haven, CT (US)

(21) Appl. No.: 15/519,759

(22) PCT Filed: Aug. 17, 2015
(86) PCT No.: PCT/US15/45503

§ 371 Date: Apr. 17, 2017

Related U.S. Application Data
(60) Provisional application No. 62/065,329, filed on Oct. 17, 2014.

(51) Int. Cl. B29C 73/10; B64F 5/40; B64C 27/473

(52) U.S. Cl. CPC B29C 73/10; B64C 27/473; B64F 5/40; B29L 2031/082

(57) ABSTRACT

A repair patch for a composite edge includes a plurality of laminations laid face-to-face in a lamination direction defined along a thickness direction of the blade edge. At least an uppermost one of the laminations includes first and second transverse peripheral edges and at least the first peripheral edge includes a first portion defining a first edge plane at a first axial location along the second peripheral edge and a second portion defining a second edge plane at a second axial location along the second peripheral edge.

### CROSS-REFERENCE TO RELATED APPLICATIONS

The present application is a 371 National Stage of International Patent Application No. PCT/US2015/045503, filed on Aug. 17, 2015, which claims priority to U.S. Provisional Application No. 62/065,329, filed on Oct. 17, 2014, the contents of which are incorporated herein by reference in their entirety.

### STATEMENT REGARDING FEDERALLY SPONSORED RESEARCH OR DEVELOPMENT

This invention was made with government support under United States Army Contract No. W911W6-12-2-0005 awarded by the Aviation Applied Technology Directorate (AATD) of the United States Army. The government has certain rights to this invention.

### BACKGROUND OF THE INVENTION

The subject matter disclosed herein relates to a repair patch and, more particularly, to a repair patch for a rotor blade.

Bonded composite structures for use in trailing edge repair operations of main rotor blades of helicopters have experienced fatigue failure modes on the outer skin ply. One such failure mode, in particular, has been observed as a delamination initiated at the edge of the repair patch which propagates rapidly toward the center of the repair patch. This type of failure mode can in some cases cause abrupt stiffness drops of repaired structure and may substantially reduce its service life. In addition, this failure mode can also lead to other delamination developments that extend to regions outside the repair zone.

In order to increase a fail-safe service life of a rotor blade, at least incidences of delamination at repair patches need to be alleviated or eliminated.

### BRIEF DESCRIPTION OF THE INVENTION

According to one aspect of the invention, a repair patch for a composite edge is provided. The repair patch includes a plurality of laminations laid face-to-face in a lamination direction defined along a thickness direction of the blade edge. At least an uppermost one of the laminations includes first and second transverse peripheral edges and at least the first peripheral edge includes a first portion defining a first edge plane at a first axial location along the second peripheral edge and a second portion defining a second edge plane at a second axial location along the second peripheral edge.

In addition to one or more of the features described above, or as an alternative, in further embodiments the blade edge includes a helicopter rotor blade edge.

In addition to one or more of the features described above, or as an alternative, in further embodiments the plurality of laminations lie over a cutout portion of the blade edge.

In addition to one or more of the features described above, or as an alternative, in further embodiments the plurality of laminations are symmetric about vertical and horizontal axes of the cutout portion.

In addition to one or more of the features described above, or as an alternative, in further embodiments the first and second portions of the first peripheral edge of the uppermost one of the laminations are each plural in number and form a saw-tooth pattern.

In addition to one or more of the features described above, or as an alternative, in further embodiments an angling of the saw tooth pattern is an angling of the cutout portion relative to the second peripheral edge.

In addition to one or more of the features described above, or as an alternative, in further embodiments the plural first and second portions include elongate edges.

In addition to one or more of the features described above, or as an alternative, in further embodiments teeth sizes of the saw tooth pattern are varied.

In addition to one or more of the features described above, or as an alternative, in further embodiments the first and second portions of the first peripheral edge of the uppermost one of the laminations are each plural in number and form a sine wave pattern.

In addition to one or more of the features described above, or as an alternative, in further embodiments portions of one or more underlying laminations form one of a saw-tooth and a sine wave pattern.

In addition to one or more of the features described above, or as an alternative, in further embodiments the uppermost one of the laminations includes a composite laminate material.

In addition to one or more of the features described above, or as an alternative, in further embodiments underlying laminations include composite laminate materials of similar and varying angling relative to the composite laminate material of the uppermost one of the laminations.

According to one aspect of the invention, a rotor blade of a helicopter is provided and includes suction and pressure surfaces that meet to define opposite leading and trailing edges, the trailing edge defining a cutout portion and including at the cutout portion a repair patch. The repair patch includes a plurality of laminations laid face-to-face in a lamination direction defined along a thickness direction of the trailing edge. At least an uppermost one of the laminations includes first and second transverse peripheral edges and at least the first peripheral edge includes a first portion defining a first edge plane at a first axial location along the second peripheral edge and a second portion defining a second edge plane at a second axial location along the second peripheral edge.

In addition to one or more of the features described above, or as an alternative, in further embodiments the first and second portions of the first peripheral edge of the uppermost one of the laminations are each plural in number and form a saw-tooth pattern.

In addition to one or more of the features described above, or as an alternative, in further embodiments an angling of the saw tooth pattern is an angling of the cutout portion relative to the second peripheral edge.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a helicopter in accordance with embodiments;

FIG. 2 is an axial view of a rotor blade of the helicopter of FIG. 1;

FIG. 3 is a plan view of a portion of the rotor blade of FIG. 2;

FIG. 4 is a schematic illustration of a repair patch for a rotor blade in accordance with embodiments;

FIG. 5 is a schematic view of the repair patch taken along line F-F in FIG. 4 but is not drawn to scale;

FIG. 6 is a view of an enlarged portion of the repair patch of FIG. 4;

FIG. 7 is a view of an enlarged portion of the repair patch of FIG. 4 in accordance with alternative embodiments; and

FIG. 8 is a schematic illustration of a repair patch for a rotor blade in accordance with alternative embodiments.

The detailed description explains embodiments of the invention, together with advantages and features, by way of example with reference to the drawings.

### DETAILED DESCRIPTION OF THE INVENTION

As will be described below, a saw tooth ply pattern with an exemplary angle of (Π/12) may be employed at an edge of a repair patch of a helicopter rotor blade. This saw tooth ply pattern reduces or spreads out in-plane shear and interlaminar shear stresses in the repair patch or at critical locations and reduces the likelihood of an incidence of delamination or delamination-related crack growth. In certain cases, a portion of the rotor blade is cutout in a given pattern (e.g., half of the Π/12 angling). This pattern may be defined to reduce stress concentrations. Moreover, the cutout size can be changed by varying its length and width to accommodate damaged areas of variable size while maintaining reduced stresses.

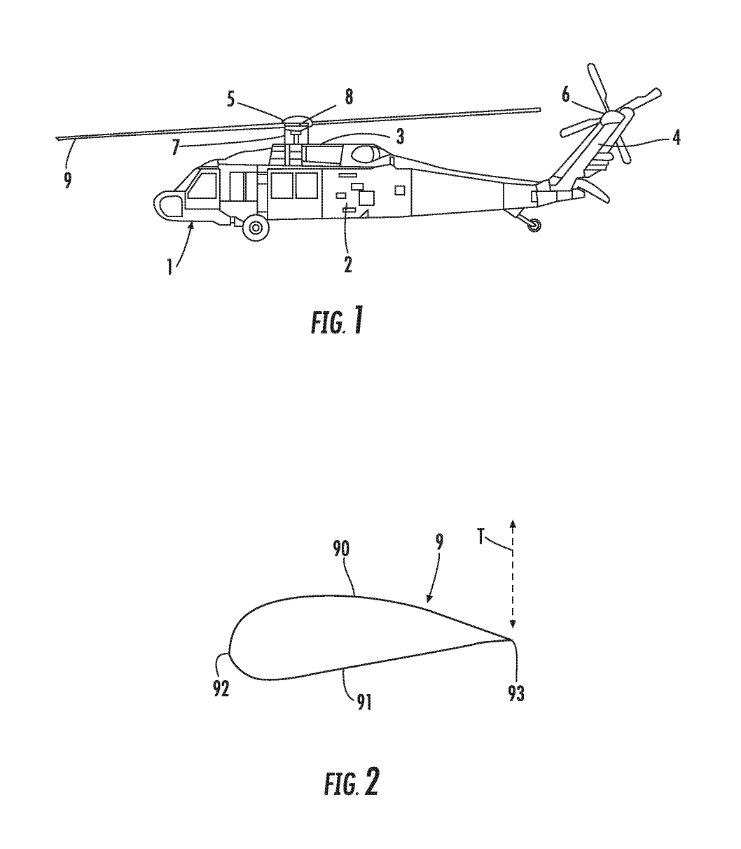

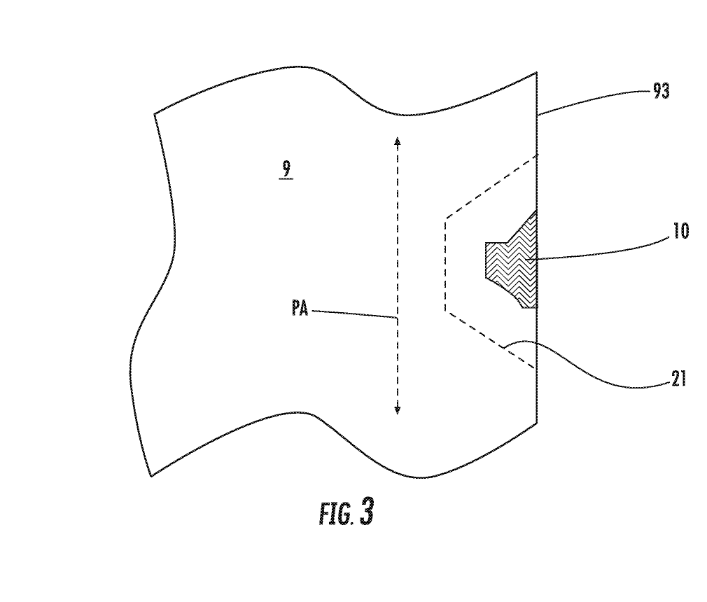

With reference to FIGS. 1 and 2, a helicopter 1 is provided and includes an airframe 2 that may be formed to define a cabin to accommodate manned or unmanned flight operations, a main rotor assembly 3 and a tail rotor assembly 4. The main rotor assembly 3 is supportive of a main rotor 5 and the tail rotor assembly 4 is supportive of a tail rotor 6 and the main rotor 5 and the tail rotor 6 are both rotatable relative to the airframe to provide for lift and thrust of the helicopter 1. The airframe 2 may be further configured to house or otherwise support an engine and a transmission system disposed to drive respective rotations of the main rotor 5 and the tail rotor 6 in accordance with flight commands (i.e., collective and cyclical flight commands) issued by a pilot and/or a flight computer.

With continued reference to FIG. 1 and, as shown in FIG. 2, at least the main rotor 5 includes a rotor shaft 7 that defines a rotational axis about which the main rotor 5 rotates, a hub 8 coupled to the rotor shaft 7 and a plurality of rotor blades 9 extending radially outwardly from the hub 8. Each rotor blade 9 includes a suction surface 90 and a pressure surface 91 opposite the suction surface 90 as well as a leading edge 92 and a trailing edge 93 opposite the leading edge 92. The leading and trailing edges 92 and 93 are defined in accordance with a movement direction of the rotor blade 9 through air and where the suction and pressure surfaces 90 and 91 meet. In accordance with embodiments, a cross-section of the rotor blade 9 has a lift generating airfoil shape.

Although the helicopter 1 shown in FIGS. 1 and 2 has a main rotor 5 and a tail rotor 6, it will be understood that this configuration is merely exemplary and that other helicopter or rotorcraft configurations are possible. For instance, the helicopter 1 may include coaxial, counter rotating main rotors and an auxiliary propulsor.

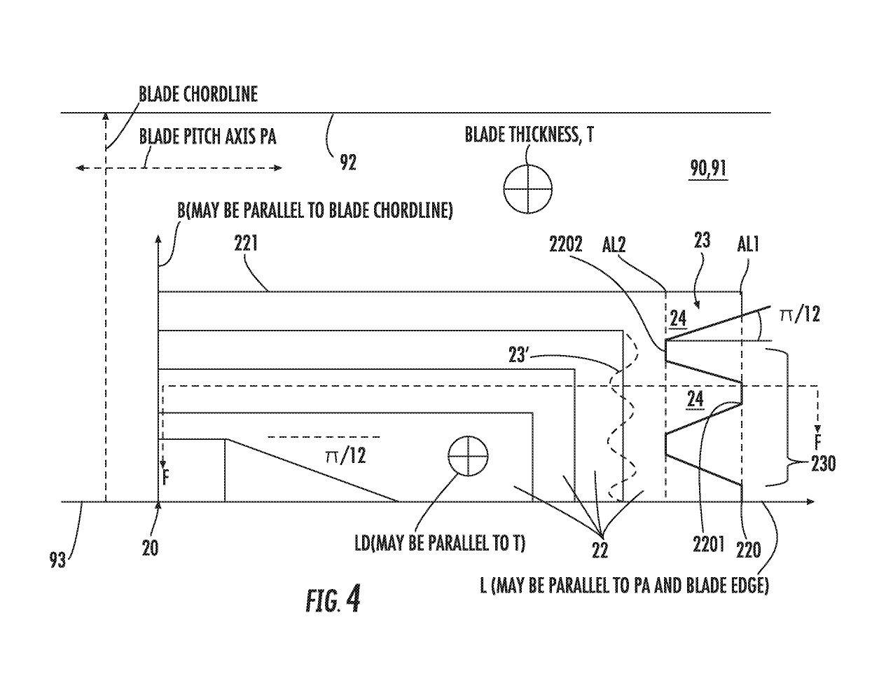

With reference to FIGS. 3 and 4, the trailing edge 93 of the rotor blade 9 may be damaged during various grounded and flight operations. An example of such damage is shown in the dent 10 illustrated in FIG. 3.

Where the trailing edge 93 of the rotor blade 9 is damaged, a repair patch 20 in accordance with embodiments may be disposed at and around the damage. This may be accomplished by initially defining a cutout portion 21 in the trailing edge 93 (see FIG. 3), removing the cutout portion 21, filling in the removed material with a filler material and then applying the repair patch 20 over the filler material in the cutout portion 21. Although the cutout portion 21 is illustrated in FIG. 3 as having a polygonal shape, it will be understood that this is not required and that other shapes for the cutout portion 21 are possible. Those shapes include, but are not limited to, elliptical shapes, shapes with segmented arc and shapes with arcs and flat portions.

The repair patch 20 includes a plurality of laminations 22, which are laid face-to-face in a lamination direction LD (see FIG. 4) defined along a thickness direction T of the trailing edge 93 (see FIG. 2) such that each lamination 22 lies substantially in parallel with a plane of a local surface of the rotor blade 9 and the resulting stack of laminations 22 rises off the local surface of the rotor blade 9. The thickness direction T is transverse to a blade pitch axis PA (see FIGS. 3 and 4) defined along a length of the rotor blade 9.

As shown in FIG. 4, there may be four laminations 22 in the repair patch 20 and sizes of each of the laminations 22 increases from an innermost and smallest lamination 22 to an uppermost and largest lamination 22. The relative sizes of the laminations 22 can be varied in accordance with particular design requirements of the repair patch 20 and the size of the damage to the rotor blade 9.

At least the uppermost one of the laminations 22 includes a first peripheral edge 220 and a second peripheral edge 221, which is oriented transversely relative to the first peripheral edge 220. The first peripheral edge 220 includes a first portion 2201 and a second portion 2202. The first portion 2201 is formed to define a first edge plane P1 at a first axial location AL1 defined along the second peripheral edge 221. The second portion 2202 is formed to define a second edge plane P2 at a second axial location AL2 defined along the second peripheral edge 221. In accordance with embodiments, the first edge plane P1 may be more distant from a central portion of the repair patch 20 than the second edge plane P2.

Only a quadrant of the repair patch 20 is illustrated in FIG. 4 for purposes of clarity and brevity and it will be understood that the repair patch 20 may include additional quadrants. In particular, it will be understood that the repair patch may be symmetric about axes B (which is defined traversely with respect to the lamination direction LD) and L (which is defined along blade pitch axis PA). In addition, the first and second portions 2201 and 2202 of the first peripheral edge 220 may each be plural in number and disposed to form a repeating pattern 23. The symmetry of the repair patch 20 may permit the repair patch 20 to be fit on the suction surface 90, over the trailing edge 93 and on the pressure surface 91 in a clamshell-type or U-shaped configuration.

As shown in FIGS. 4 and 6, the repeating pattern 23 may be provided as a saw tooth ply pattern 230. In such cases, the second peripheral edge 221 of the uppermost lamination 22 extends to a distal point where an end of the second peripheral edge 221 intersects with a complementary end of one of the plural first portions 2201. This first portion 2201 extends as an elongate edge transversely or perpendicularly relative to the second peripheral edge 221 along the first edge plane P1 to a distal point where an end of the first portion 2201 intersects with a first angled portion 2203. This first angled portion 2203 extends at an obtuse angle (e.g., 105°) relative to the first portion 2201 to a distal point where an end of the first angled portion 2203 intersects with a complementary end of one of the plural second portions 2202. This second portion 2202 extends as an elongate edge at an obtuse angle (e.g., 105°) relative to the first angled portion 2203 along the second edge plane P2 to a distal point where an end of the second portion 2202 intersects with a second angled portion 2204. This second angled portion 2204 extends at an obtuse angle (e.g., 105°) relative to the second portion 2202 to a distal point where an end of the second angled portion 2204 intersects with a complementary end of another one of the plural first portions 2201.

The saw tooth ply pattern 230 described above may be repeated along a portion of or along the entirety of the first peripheral edge 220 of the uppermost one of the laminations 22. In each repeated iteration the corresponding first portion 2201 and the corresponding first and second angled portions 2203 and 2204 form a saw tooth 24 extending outwardly from the second edge plane P2. Each saw tooth 24 may have a similar size as the other saw teeth 24 or a unique size. The saw tooth ply pattern 230 may also be formed at the second peripheral edge 221 as well although a description of this configuration would be similar to the description provided herein and is omitted for brevity.

The angling of the first and second angled portions 2203 and 2204 relative to the second peripheral edge 221 may be about ±Π/12 (see FIG. 4). Similarly, an angling of a peripheral edge 210 of the cutout portion 21 may be about Π/12 (see FIG. 4). Regardless of the actual angling of the first and second angled portions 2203 and 2204 and the peripheral edge 210, however, an angling of the saw tooth ply pattern 230 may be generally based on an angling of the cutout portion 21.

In accordance with embodiments, it will be understood that the exemplary angling described above need not be consistent throughout the entire repair patch 20 and indeed may change along the chord-wise direction for example. In addition, the corners of the saw tooth ply pattern 230 may be rounded at a microscopic or small-scale level.

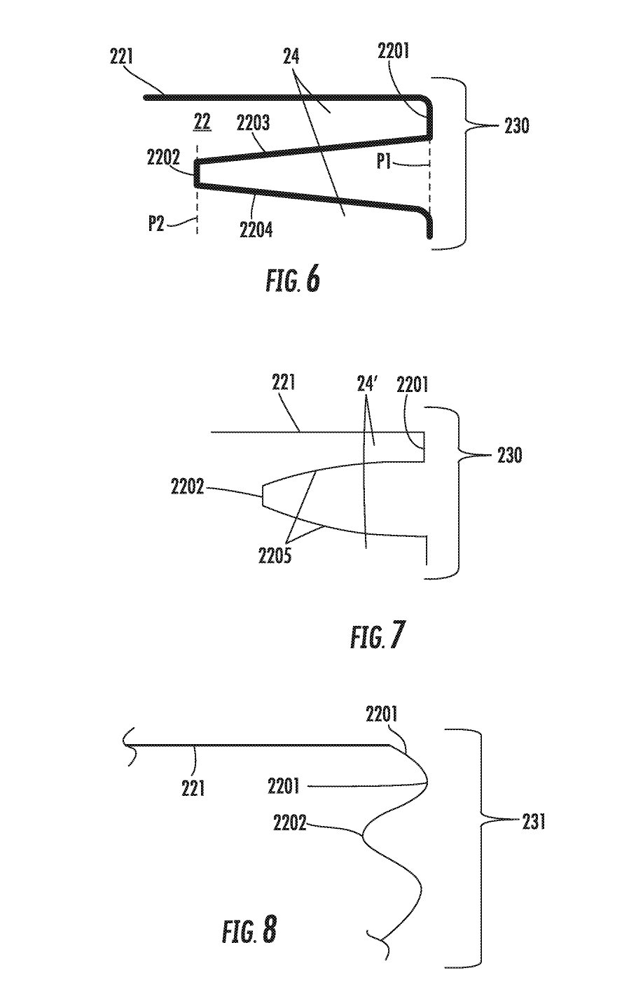

Although the first and second angled portions 2203 and 2204 are illustrated in FIG. 6 as being substantially straight, it will be understood that this is not required and that other configurations are possible. For example, as shown in FIG. 7, the saw tooth ply pattern 230 may include curved portions 2205 extending between corresponding first and second portions 2201 and 2202. These curved portions 2205 may form convex or concave saw teeth 24′ in accordance with various embodiments.

With reference to FIG. 8 and, in accordance with further embodiments, the first and second portions 2201 and 2202 of the first peripheral edge 220 of the uppermost one of the laminations 22 may each be plural in number and formed to define a continuously uniform or varying sine wave pattern 231 along a portion of or along the entirety of the first peripheral edge 220 of the uppermost one of the laminations 22. The sine wave pattern 231 may also be formed at the second peripheral edge 221 as well although a description of this configuration would be similar to the description provided herein and is omitted for brevity.

With reference to FIG. 4 and, in accordance with further embodiments of the invention, the uppermost one of the laminations 22 may be formed to define the repeating pattern 23 described above and at least one or more of the underlying ones of the laminations 22 may also be formed to define additional repeating patterns 23′. These additional repeating patterns 23′ may be similar to one another and to the repeating pattern 23 or different in accordance with particular design requirements of the repair patch 20 and the size of the damage to the rotor blade 9.

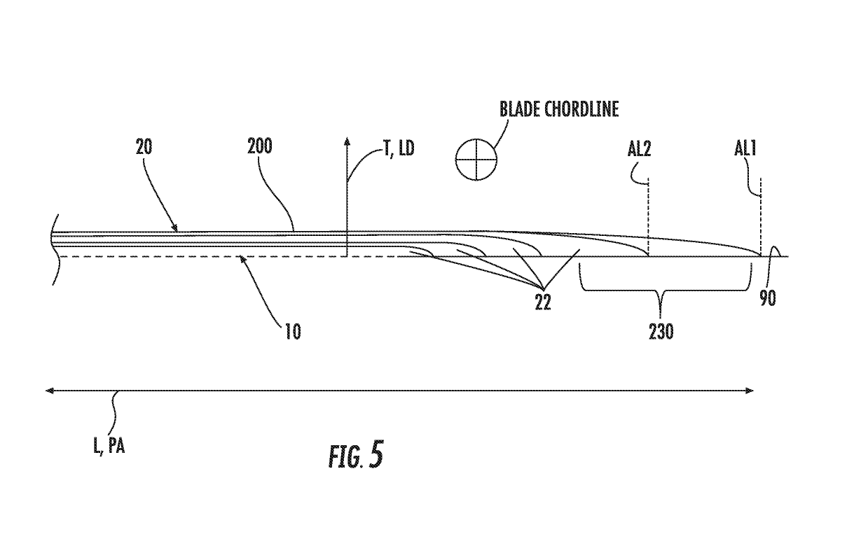

With reference to FIGS. 4 and 5 (FIG. 5 not being drawn to scale), the uppermost one of the laminations 22 lies atop the repair patch 20. In this way the upper (or outwardly facing) surface of the uppermost one of the laminations 22 forms the upper (or outwardly facing) surface 200 of the repair patch 20. However, it is to be understood that a further layer or non-structural skin may be provided over the surface 200 in order to provide additional adhesive or protection to the uppermost one of the laminations 22.

In accordance with still further embodiments, at least the uppermost one of the laminations 22 may include, for example, a glass fiber woven composite material and the underlying ones of the laminations 22 may include, for example, a glass fiber woven composite materials of similar and varying angling relative to the glass fiber woven composite material of the uppermost one of the laminations 22. For each lamination 22 having a repeating pattern 23 (or 23′), the angling of the woven glass fibers may be transverse to the angling of the first and second angled portions 2203 and 2204 in the case of the saw tooth ply pattern 230 or the “faces” of the sine wave pattern 231. Thus, for the repair patch 20 of FIG. 4, the uppermost and next uppermost ones of the laminations 22 may each have glass fiber angling of about 45° relative to the second peripheral edge 221 and the two innermost ones of the laminations 22 may each have glass fiber angling of about 0°. While not required in all aspects, the repair patch 20 can be prepared and distributed for use in field repairs instead of laid up and cured at the location where the repair is being made.

Of course it is to be understood that the materials described above are not required and that other materials may be used. These other materials include graphite and combinations of graphite with glass fiber. Still other materials may include aluminum wire mesh.

As used herein, the notion of the various axes being parallel to one another has been included to bring clarity to the descriptions. That is, the various axes being parallel may be present in some embodiments but is not required in all embodiments. For example, rotor blade 9 can taper such that axes that are parallel at one section of the rotor blade 9 may not be parallel at another.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. By way of example, while described in terms of a helicopter, it is understood that aspects can be used in fixed wing aircraft, wind turbines, or automobiles, maritime vehicles, architectural structures, or other applications where patches are required on a composite edge of a part. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A repair patch for a composite edge, comprising:
a plurality of laminations laid face-to-face in a lamination direction defined along a thickness direction of the blade edge,
at least an uppermost one of the laminations comprising first and second transverse peripheral edges, at least the first peripheral edge comprising:
a first portion defining a first edge plane at a first axial location along the second peripheral edge; and
a second portion defining a second edge plane at a second axial location along the second peripheral edge.

2. The repair patch according to claim 1, wherein the blade edge comprises a helicopter rotor blade edge.

3. The repair patch according to claim 1, wherein the plurality of laminations lie over a cutout portion of the blade edge.

4. The repair patch according to claim 3, wherein the plurality of laminations are symmetric about vertical and horizontal axes of the cutout portion.

5. The repair patch according to claim 1, wherein the first and second portions of the first peripheral edge of the uppermost one of the laminations are each plural in number and form a saw-tooth pattern.

6. The repair patch according to claim 5, wherein an angling of the saw tooth pattern is an angling of the cutout portion relative to the second peripheral edge.

7. The repair patch according to claim 5, wherein the plural first and second portions comprise elongate edges.

8. The repair patch according to claim 5, wherein teeth sizes of the saw tooth pattern are varied.

9. The repair patch according to claim 1, wherein the first and second portions of the first peripheral edge of the uppermost one of the laminations are each plural in number and form a sine wave pattern.

10. The repair patch according to claim 1, wherein portions of one or more underlying laminations form one of a saw-tooth and a sine wave pattern.

11. The repair patch according to claim 1, wherein the uppermost one of the laminations comprises a composite laminate material.

12. The repair patch according to claim 11, wherein underlying laminations comprise composite laminate materials of similar and varying angling relative to the composite laminate material of the uppermost one of the laminations.

13. A rotor blade of a helicopter, comprising:
suction and pressure surfaces that meet to define opposite leading and trailing edges,
the trailing edge defining a cutout portion and including at the cutout portion a repair patch comprising:
a plurality of laminations laid face-to-face in a lamination direction defined along a thickness direction of the trailing edge,
at least an uppermost one of the laminations comprising first and second transverse peripheral edges, at least the first peripheral edge comprising:
a first portion defining a first edge plane at a first axial location along the second peripheral edge; and
a second portion defining a second edge plane at a second axial location along the second peripheral edge.

14. The rotor blade according to claim 13, wherein the first and second portions of the first peripheral edge of the uppermost one of the laminations are each plural in number and form a saw-tooth pattern.

15. The rotor blade according to claim 14, wherein an angling of the saw tooth pattern is an angling of the cutout portion relative to the second peripheral edge.
